(19) United States
(12) Patent Application Publication
(10) Pub. No.: US 2013/0207912 A1
(43) Pub. Date: Aug. 15, 2013

(54) DETACHABLE ELECTRONIC DEVICE

(71) Applicant: Wistron Corporation, (US)

(72) Inventors: Chi-Hai Tso, New Taipei City (TW); Kuang-Hung Chen, New Taipei City (TW); Ren-Jing Wei, New Taipei City (TW)

(73) Assignee: WISTRON CORPORATION, New Taipei City (TW)

(21) Appl. No.: 13/706,339

(22) Filed: Dec. 5, 2012

(30) Foreign Application Priority Data
Feb. 13, 2012 (TW) 101202548

(51) Int. Cl. G06F 3/041

(52) U.S. Cl. CPC G06F 3/041
USPC 345/173

(57) ABSTRACT

A detachable electronic device having monolithic appearance is disclosed in the present invention. The detachable electronic device includes a base, a touch pad disposed on the base, and an exterior casing detachably disposed on the base. The exterior casing includes a touch area, the touch area covers above the touch pad, and the exterior casing is a monolithic component. The detachable electronic device further includes a soft buffering component disposed between the touch pad and the exterior casing. A gap between the touch pad and the exterior casing is filled with the soft buffering component, so that the exterior casing can drive the soft buffering component to be deformed when the exterior casing is pressed, so as to actuate a switch of the touch pad.

### BACKGROUND OF THE INVENTION

1. Field of the Invention

The present invention relates to a detachable electronic device, and more particularly, to a detachable electronic device capable of exchanging its exterior casing easily and meantime keeping monolithic appearance.

2. Description of the Prior Art

With the advanced technology, the portable electronic device, such as a notebook computer, a translation machine, a handheld video game or a smart phone, trends to thin and slight design. The portable electronic device provides innovative outward appearance for new fashion spirits, so as to show popular brand feature. For example, the conventional handheld phone has functions to exchange its casing. The colorful casing can be replaced arbitrarily according to user's demand. Besides, an input interface of the conventional portable electronic device, such as the touch pad, can be designed as a detachable component.

The touch pad of the conventional portable electronic device is pasted on the exterior casing by adhesive for increasing the effective touch sensitivity. The adhesive method may hurt the elements of the portable electronic device. For example, the touch pad is hard to separate from the exterior casing, a part of the adhesive remains on the exterior casing, and the touch pad is damaged easily due to the adhesive with high viscosity. In addition, the touch pad and the exterior casing of the other type of the conventional portable electronic device are isolated elements. A hole is formed on the surface of the exterior casing to expose the touch pad, so the portable electronic device does not have monolithic appearance because the exterior casing and the exposed touch pad are visible. The type of the conventional portable electronic device is unpopular because the exterior casing and the touch pad does not show the unitary appearance. Thus, design of a touch device capable of arbitrarily replacing the exterior casing and meantime keeping the unitary appearance is an important issue in the mechanical industry.

### SUMMARY OF THE INVENTION

The present invention provides a detachable electronic device capable of exchanging its exterior casing easily and meantime keeping monolithic appearance for solving above drawbacks.

According to the claimed invention, a detachable electronic device having monolithic appearance is disclosed. The detachable electronic device includes a base, a touch pad disposed on the base, an exterior casing detachably disposed on the base, and a soft buffering component disposed between the touch pad and the exterior casing. The exterior casing includes a touch area, the touch area covers above the touch pad, and the exterior casing is a monolithic component. A gap between the touch pad and the exterior casing is filled with the soft buffering component, so that the exterior casing drives the soft buffering component to be deformed when the exterior casing is pressed, so as to actuate a switch of the touch pad.

According to the claimed invention, the detachable electronic device further includes a bridging component disposed between the base and the exterior casing. A hole is formed on a surface of the bridging component, and a position of the hole aligns with the touch pad.

According to the claimed invention, the detachable electronic device further includes a keyboard module disposed on the bridging component and located at a position that does not overlap the hole on the bridging component.

According to the claimed invention, the soft buffering component is disposed on the touch pad by adhesive.

According to the claimed invention, the soft buffering component contacts an inner surface of the exterior casing via compressible deformation.

According to the claimed invention, the soft buffering component is made of silica gel material, rubber material and sponge material.

According to the claimed invention, the touch pad is fixed on the base by a screw, a fastener and adhesive.

According to the claimed invention, the exterior casing is disposed on the base by a removable buckling structure.

According to the claimed invention, a thickness of the soft buffering component is substantially greater than resilient deformation of the touch area on the exterior casing.

According to the claimed invention, a method of fabricating a detachable electronic device having monolithic appearance is disclosed. The method includes disposing a touch pad on a base, disposing a soft buffering component on a surface of the touch pad opposite to the base, disposing a bridging component on the base to align a hole on the bridging component with the touch pad, disposing a keyboard module on the bridging component, and disposing an exterior casing on the base in a detachable manner. The keyboard module does not overlap the hole on the bridging component. A touch area on the exterior casing covers above the soft buffering component, and the exterior casing is a monolithic component.

The detachable electronic device of the present invention can dispose the soft buffering component between the touch pad and the touch area on the monolithic exterior casing. Due to the compression and the viscosity of the soft buffering component, the soft buffering component does is immovable relative to the exterior casing when the detachable electronic device is assembled. There is no residual adhesive on the exterior casing after the exterior casing is removed from the base, so the present invention can provide advantages of monolithic appearance and assembly convenience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a detachable electronic device according to an embodiment of the present invention.

FIG. 2 is an exploded diagram of the detachable electronic device according to the embodiment of the present invention.

FIG. 3 to FIG. 5 respectively are assembly diagrams of a base and a touch pad 1 according to different embodiments of the present invention.

FIG. 6 is a flow chart of fabricating the detachable electronic device according to the embodiment of the present invention.

### DETAILED DESCRIPTION

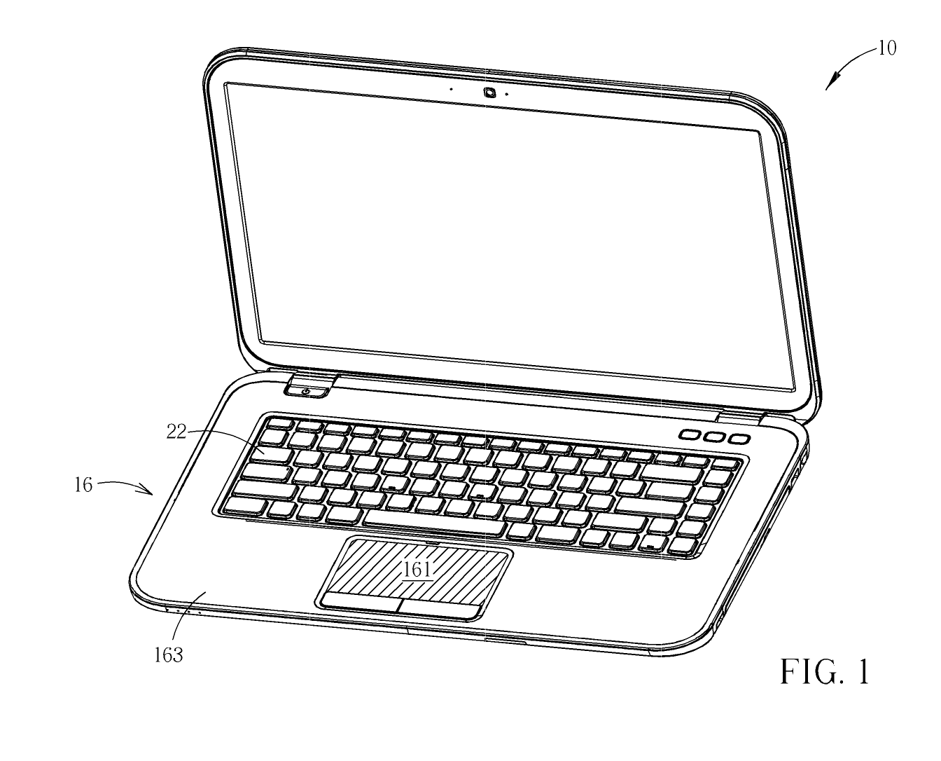

Please refer to FIG. 1. FIG. 1 is a diagram of a detachable electronic device 10 according to an embodiment of the present invention. The detachable electronic device 10 can be the electronic device having monolithic appearance. For example, the detachable electronic device 10 can be a notebook computer, a translation machine, a handheld video game or a smart phone. An input interface of the detachable electronic device 10, such as a keyboard module and a touch pad, can be the monolithic components and be covered by the removable casing, so that the detachable electronic device 10 shows the colorful unitary appearance.

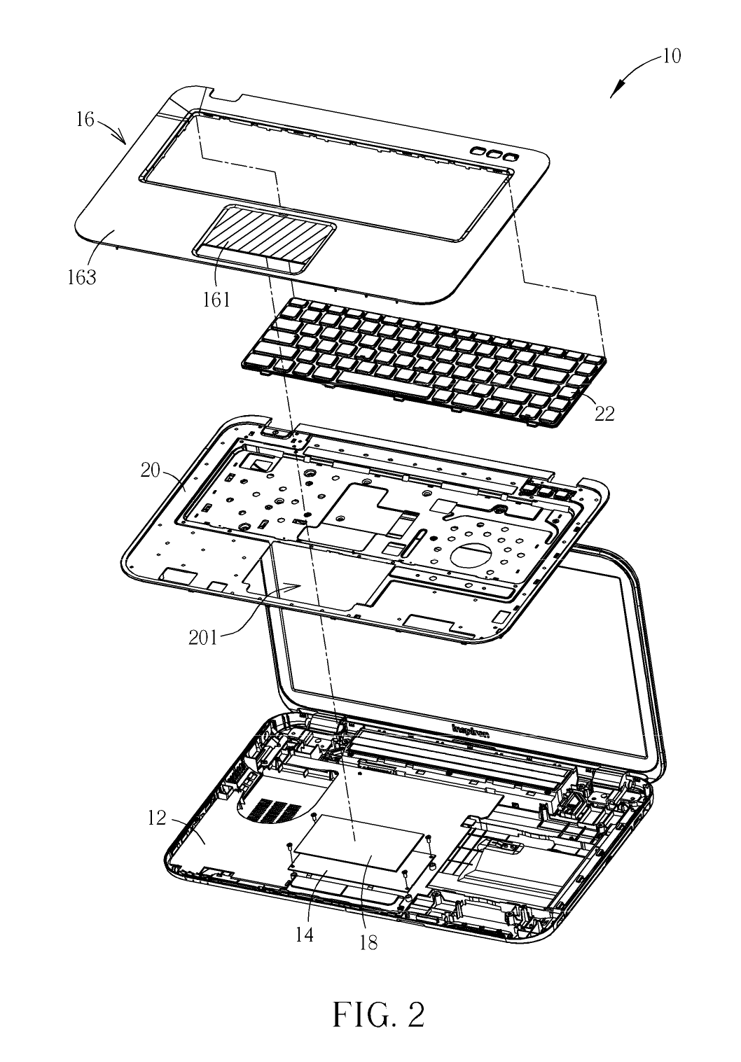

Please refer to FIG. 2. FIG. 2 is an exploded diagram of the detachable electronic device 10 according to the embodiment of the present invention. The detachable electronic device 10 includes a base 12, a touch pad 14, an exterior casing 16, a soft buffering component 18, a bridging component 20 and a keyboard module 22. The base 12 can be a bottom of the detachable electronic device 10 for supporting interior electronic elements of the detachable electronic device 10. The touch pad 14 can be disposed on the base 12. In the embodiment, the touch pad 14 is fixed on the base 12 by a screw. Fixing method of the touch pad 14 is not limited to the above-mentioned embodiment, and depends on design demand. For example, the touch pad 14 can be fixed on the base 12 by a fastener or adhesive,

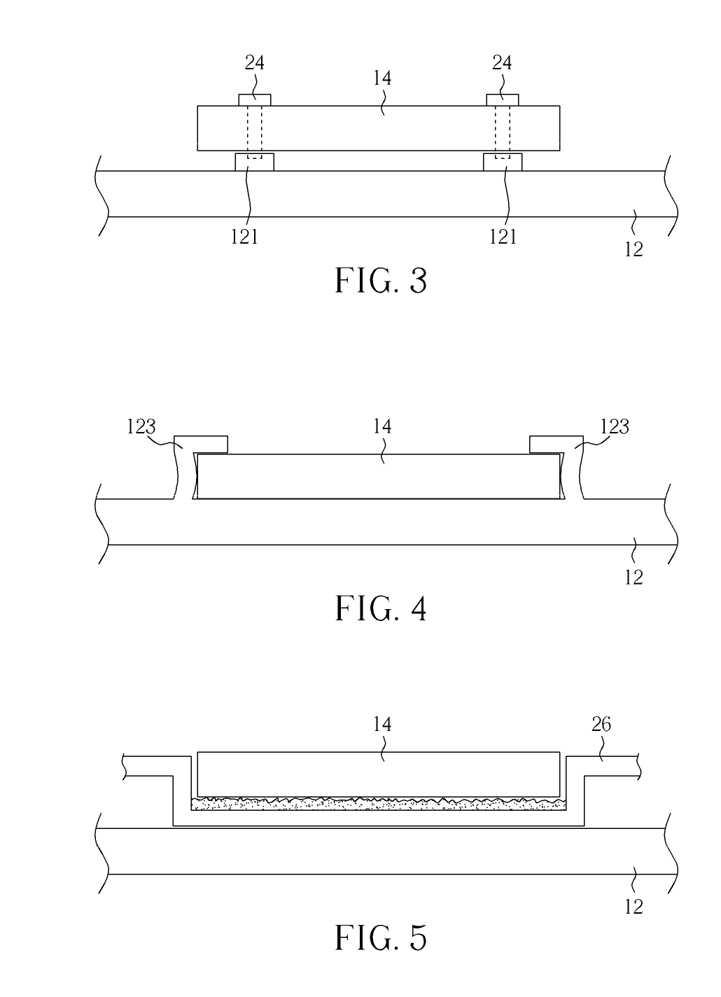

Please refer to FIG. 3 to FIG. 5. FIG. 3 to FIG. 5 respectively are assembly diagrams of the base 12 and the touch pad 14 according to different embodiments of the present invention. As shown in FIG. 3, a plurality of screws 24 can be utilized to pierce through the touch pad 14 and then to lock on a boss 121 of the base 12, so as to fix the touch pad 14 on the base 12. As shown in FIG. 4, the base 12 can selectively include a plurality of removable buckling structures 123. Each buckling structure 123 can buckle the corresponding edge of the touch pad 14 when the touch pad 14 is put on the surface of the base 12, so as to constrain a movement of the touch pad 14 relative to the base 12. As shown in FIG. 5, the detachable electronic device 10 can further include an accommodating component 26 disposed on the base 12. The accommodating component 26 can be made of metal material, such as iron material. A slot can be formed on a surface of the accommodating component 26. The touch pad 14 can be set inside the slot by the adhesive with greater viscosity, so as to prevent the touch pad 14 from separating from the base 12.

As shown in FIG. 1 to FIG. 5, the exterior casing 16 of the present invention is a decorative structure, and can be detachably disposed on the base 12 (in a detachable manner). For example, the present invention can utilize the removable buckling structure to fix the exterior casing 16 on the base 12, so as to cover the inner space of the detachable electronic device 10 for protection. A part of the exterior casing 16 aligning with the touch pad 14 can be integrated with the other part of the exterior casing 16 monolithically. It is to say, the exterior casing 16 can include a touch area 161 and a protect area 163, and the touch area 161 is integrated with the protect area 163 monolithically. The touch area 161 can cover above the soft buffering component 18 (it also above the touch pad 14), and the protect area 163 covers the bridging component 20 for protection, so the touch area 161 on the exterior casing 16 can be the part aligning with the touch pad 14 accordingly. Therefore, the touch area 161 can be pressed to actuate a switch of the touch pad 14 that is located under the touch area 161 by deformation. Because the exterior casing 16 is a monolithic component, the touch pad 14 and the soft buffering component 18 are not exposed and completely covered by the exterior casing 16, so that appearance of the detachable electronic device 10 can have the colorful unitary.

As shown in FIG. 2, the soft buffering component 18 can be disposed between the touch pad 14 and the touch area 161 on the exterior casing 16. The soft buffering component 18 can be a cushion made of silica gel material, rubber material and sponge material, which is deformable by compression. A gap between the touch pad 14 and the exterior casing 16 can be filled with the soft buffering component 18. When the touch area 161 on the exterior casing 16 is pressed, the soft buffering component 18 can be deformed due to the compression from the touch area 161, so as to touch (or click) the switch of the touch pad 14 for outputting the corresponding signal. Because the exterior casing 16 is the detachable structure, the soft buffering component 18 can be pasted on the touch pad 14 by the adhesive for convenient assembly, and the exterior casing 16 can slightly press over the soft buffering component 18. The soft buffering component 18 can fully contact an inner surface of the exterior casing 16 via the compressible deformation. Thus, the soft buffering component 18 can be removed from the exterior casing 16 easily for disassembly due to pressure disappearance, and the soft buffering component 18 is still adhered on the touch pad 14.

Generally, a thickness of the soft buffering component 18 can be substantially greater than resilient deformation of the touch area 161 on the exterior casing 16. As the soft buffering component 18 is made of the silica gel material, the exterior casing 16 presses the soft buffering component to be deformed when the exterior casing 16 is disposed on the base 12, and the exterior casing 16 can fully contact the soft buffering component 18 by viscidity of the soft buffering component 18 generated by its friction and vacuum absorbability. Therefore, the present invention can keep the soft buffering component 18 immovable relative to the touch area 161 on the exterior casing 16 without the adhesive.

As shown in FIG. 2, the bridging component 20 can be disposed between the base 12 and the exterior casing 16. A hole 201 can be formed on a surface of the bridging component 20, and a position of the hole 201 can align with the touch pad 14. When the bridging component 20 is fixed on the base 12, the touch pad 14 can be exposed through the hole 201 for contacting the touch area 161 on the exterior casing 16 via the soft buffering component 18. The keyboard module 22 can be a common keyboard disposed on the bridging component 20. A position of the keyboard module 22 does not overlap the hole 201 on the bridging component 20. Generally, the detachable electronic device 10 can be the notebook computer, the keyboard module 22 can be the normal keyboard, the touch pad 14 can be applied to mouse operation, and a user can press the touch area 161 on the exterior casing 16 to actuate the switch of the touch pad 14.

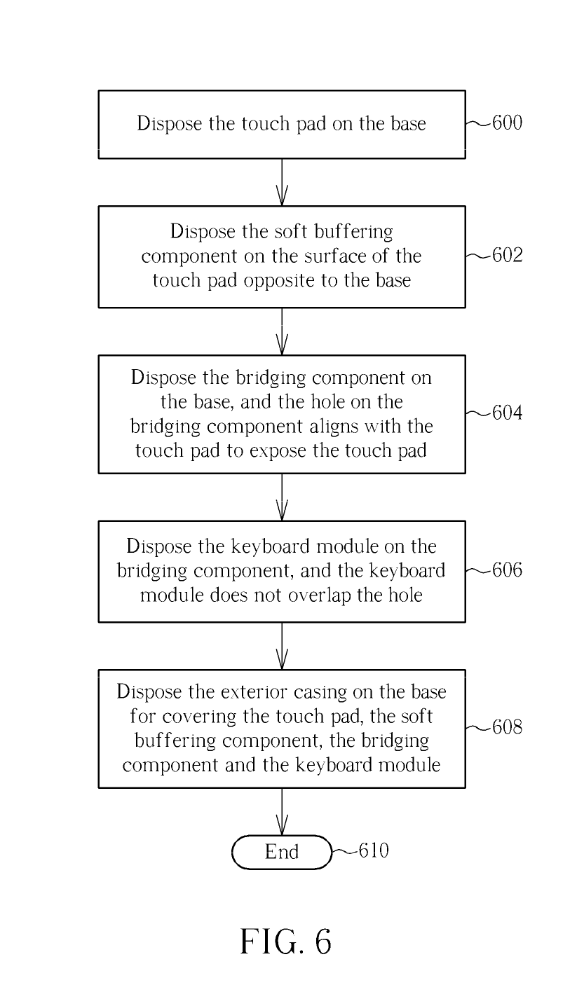

Please refer to FIG. 6. FIG. 6 is a flow chart of fabricating the detachable electronic device 10 according to the embodiment of the present invention. The method includes following steps:

Step 600: Dispose the touch pad 14 on the base 12.

Step 602: Dispose the soft buffering component 18 on the surface of the touch pad 14 opposite to the base 12.

Step 604: Dispose the bridging component 20 on the base 12. The hole 201 on the bridging component 20 aligns with the touch pad 14 to expose the touch pad 14.

Step 606: Dispose the keyboard module 22 on the bridging component 20, and the keyboard module 22 does not overlap the hole 201 on the bridging component 20.

Step 608: Dispose the exterior casing 16 on the base 12 in the detachable manner for covering the touch pad 14, the soft buffering component 18, the bridging component 20 and the keyboard module 22. The touch area 161 on the exterior casing 16 is located above the soft buffering component 18.

Step 610: End.

Detail description of the procedures is introduced as following. For assembling the detachable electronic device 10, the screw, the fastener and the adhesive can be selectively utilized to fix the touch pad 14 on the base 12, as shown in FIG. 3 to FIG. 5. A surface of the soft buffering component 18 with the adhesive can be pasted on the touch pad 14, and the bridging component 20 and the keyboard module 22 are assembled in sequence. Because the touch pad 14 contacts the touch area 161 on the exterior casing 16 via the soft buffering component 18, the hole 201 on the bridging component 20 can be formed, and the touch pad 14 can be connected to the touch area 161 via the soft buffering component 18 through the hole 201.

In addition, the touch pad 14 of the present invention can be applied to the mouse operation, the keyboard module 22 can be disposed by the hole 201 on the bridging component 20, so that the keyboard module 22 does not overlap a part of the exterior casing 16 where the soft buffering component 18 contacts. Final, the removable buckling structure can be utilized to fix the exterior casing 16 on the base 12. The touch area 161 on the exterior casing 16 can align with the touch pad 14 and the soft buffering component 18, and the thickness of the soft buffering component 18 can be substantially greater than the resilient deformation of the touch area 161 on the exterior casing 16, which means the gap between the exterior casing 16 and the touch pad 14 is filled with the soft buffering component 18. Therefore, the soft buffering component 18 can be resiliently deformed by compression when the exterior casing 16 is disposed on the base 12, and the soft buffering component 18 can fully contact the exterior casing 16 by the adhesive that generates from its friction and resilient recovering force. As replacing the exterior casing 16, the exterior casing 16 can be separated from the base 12 by removing the buckling structure; meanwhile, the soft buffering component 18 is not adhered to the exterior casing 16 due to the compression disappearance for rapid separation, so that appearance of the detachable electronic device 10 can be changed easily and conveniently.

In conclusion, the detachable electronic device of the present invention disposes the soft buffering component between the base and the exterior casing, and the exterior casing can be connected to the base tightly by the viscosity of the soft buffering component from the compressible deformation. With the friction and the vacuum absorbability generated by the compressible deformation, the soft buffering component can further be made of colloid material having adherent function and dustproof function selectively, so the soft buffering component can be recycled for environment-friendly lifestyle. The monolithic exterior casing of the present invention can cover above the touch pad and the soft buffering component to show the colorful unitary appearance. The soft buffering component of the present invention can be tightly disposed between the exterior casing and the touch pad by the compressible deformation, which not only can fill a crack that is generated by deformation of the touch area on the exterior casing, but also can decrease assembly tolerance of the detachable electronic device according to design demand. The soft buffering component of the present invention can be immovable relative to the touch area on the exterior casing by the compression, and can further be separated from the exterior casing rapidly due to the compression disappearance, so that the present invention can avoid drawbacks of the residual adhesive, and can change the monolithic colorful appearance of the detachable electronic device by replacing the exterior casing conveniently.

Comparing to the prior art, the detachable electronic device of the present invention can dispose the soft buffering component between the touch pad and the touch area on the monolithic exterior casing. Due to the compression and the viscosity of the soft buffering component, the soft buffering component does is immovable relative to the exterior casing when the detachable electronic device is assembled. There is no residual adhesive on the exterior casing after the exterior casing is removed from the base, so the present invention can provide advantages of monolithic appearance and assembly convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detachable electronic device having monolithic appearance, the detachable electronic device comprising:
a base;
a touch pad disposed on the base;
an exterior casing detachably disposed on the base, the exterior casing comprising a touch area, the touch area covering above the touch pad, and the exterior casing being a monolithic component; and
a soft buffering component disposed between the touch pad and the exterior casing, a gap between the touch pad and the exterior casing being filled with the soft buffering component, so that the exterior casing drives the soft buffering component to be deformed when the exterior casing is pressed, so as to actuate a switch of the touch pad.

2. The detachable electronic device of claim 1, further comprising:
a bridging component disposed between the base and the exterior casing, a hole being formed on a surface of the bridging component, and a position of the hole aligning with the touch pad.

3. The detachable electronic device of claim 2, further comprising:
a keyboard module disposed on the bridging component and located at a position that does not overlap the hole on the bridging component.

4. The detachable electronic device of claim 1, wherein the soft buffering component is disposed on the touch pad by adhesive.

5. The detachable electronic device of claim 4, wherein the soft buffering component contacts an inner surface of the exterior casing via compressible deformation.

6. The detachable electronic device of claim 1, wherein the soft buffering component is made of silica gel material, rubber material and sponge material.

7. The detachable electronic device of claim 1, wherein the touch pad is fixed on the base by a screw, a fastener and adhesive.

8. The detachable electronic device of claim 1, wherein the exterior casing is disposed on the base by a removable buckling structure.

9. The detachable electronic device of claim 1, wherein a thickness of the soft buffering component is substantially greater than resilient deformation of the touch area on the exterior casing.

10. A method of fabricating a detachable electronic device having monolithic appearance, the method comprising:
disposing a touch pad on a base;
disposing a soft buffering component on a surface of the touch pad opposite to the base;
disposing a bridging component on the base to align a hole on the bridging component with the touch pad;
disposing a keyboard module on the bridging component, wherein the keyboard module does not overlap the hole on the bridging component; and
disposing an exterior casing on the base in a detachable manner, wherein a touch area on the exterior casing covers above the soft buffering component, and the exterior casing is a monolithic component.

11. The method of claim 10, wherein disposing the soft buffering component on the surface of the touch pad opposite to the base comprises:
utilizing adhesive to paste the soft buffering component to the surface of the touch pad opposite to the base.

12. The method of claim 10, wherein the soft buffering component contacts an inner surface of the exterior casing via compressible deformation when the exterior casing is detachably disposed on the base.

13. The method of claim 10, wherein the soft buffering component is made of silica gel material, rubber material and sponge material.

14. The method of claim 10, wherein disposing the touch pad on the base comprises:
utilizing a screw, a fastener and adhesive to fix the touch pad on the base.

15. The method of claim 10, wherein disposing the exterior casing on the base in the detachable manner comprises:
utilizing a removable buckling structure to fix the exterior casing on the base.

16. The method of claim 10, wherein a thickness of the soft buffering component is substantially greater than resilient deformation of the touch area on the exterior casing.
